(19) United States
(12) Patent Application Publication
(10) Pub. No.: US 2007/0225543 A1
(43) Pub. Date: Sep. 27, 2007

(54) SONICATION TREATMENT OF MEDIA CONTAINING HALOGENATED ORGANIC COMPOUNDS

(75) Inventors: Lorrie Hunt, Delta (CA); Rod McElroy, Vancouver (CA); Jim McKinley, North Vancouver (CA)

Correspondence Address: VERMETTE & CO., SUITE 320 - 1177 WEST HASTINGS STREET, VANCOUVER, BC, V6E2K3, CA

(73) Assignee: Sonic Environmental Solutions Inc., Vancouver (CA)

(21) Appl. No.: 11/755,667

(22) Filed: May 30, 2007

Related U.S. Application Data
(63) Continuation-in-part of application No. 11/163,802, filed on Oct. 31, 2005, now abandoned.
(63) Continuation-in-part of application No. 10/511,878, filed on Oct. 19, 2004, now Pat. No. 6,984,767.

(51) Int. Cl. A62D 3/13

(52) U.S. Cl. 588/304

(57) ABSTRACT

The invention consists of a method for treating media containing halogenated organic compounds (HOC's), including Persistent Organic Pollutants (POP), by: a) combining the media with a fluid containing one or more liquid hydrocarbons to form a media/fluid mixture; b) sonicating the mixture at audio frequency; and c) treating the fluid with sodium sonically dispersed in-situ in its molten state. The method may include additional steps to reduce the solids size of the media and to distill or extract HOC's from contaminated media Alternatively, the fluid can be decanted from the media after sonication, and treated separately with an alkali metal sonically dispersed in-situ in its molten state

### RELATED APPLICATIONS

This application is a Continuation-in-Part of U.S. patent application Ser. No. 11/163,802, filed Oct. 31, 2005, which was a continuation-in-part of U.S. patent application Ser. No. 10/511,878, filed on Apr., 23, 2003, which claimed the benefit of U.S. Provisional Appln. No. 60/374,512, filed on Apr. 23, 2002.

### FIELD OF INVENTION

This invention is related to the treatment of media containing, or contaminated with, halogenated organic compounds.

### BACKGROUND OF INVENTION

The existence of large numbers of sites, with soil, ballast pitch/tar residue, combustion ash and other media contaminated by halogenated organic compounds, such as polychlorinated biphenyls (PCB's), pesticides, herbicides, dioxins, furans, etc., requires economical cost effective treatment methods. Such halogenated organic compounds are referred to herein as HOC's

Although incineration has been shown to destroy HOC's, incineration has been implicated in the emissions of highly toxic substances, and has been banned from use in certain countries such as Australia and Japan (Costner, Pat et al., 1998, “Technical Criteria for the Destruction of Stockpiled Persistent Organic Pollutants”, Third Meeting of the Intersessional Group Intergovernmental Forum on Chemical Safety, Yokohama, Japan, Dec. 1-4, 1998; see also “Survey of Currently Available Non-Incineration PCB Destruction Technologies”, United Nations Environment Programme, August 2000). Incineration may result in the production and release into the environment of compounds that are more toxic than the original contaminants Accordingly, there exists a need for means for cost effective HOC decontamination for a variety of media, including soil and ballast residue, which do not involve incineration

One class of HOC's, namely PCB's, (approximate formula C₁₂H₅Cl₅) were manufactured under various trade names (e g Arochlor 1242, 1248, 1254, 1260) and extensively used in electrical equipment, particularly as a dielectric in transformers and capacitors Prior to recognition of their environmentally hazardous nature, PCB's were also used in unconfined applications such as pesticide extenders and fire retardants (e.g. see MSDS for Arochlor 1242, 1248, 1254, 1260, etc.) In addition, over the years, industrial operations have resulted in significant contamination of soils adjacent to facilities involved in the manufacture and repair of electrical equipment as well as other operations using PCB's

Another significant source of PCB-contaminated material is fluorescent light ballasts manufactured before 1980 Ballasts are regulated by law in the US (see for example, 40 CFR 761). A sample summary of applicable rules is presented in a Minnesota Pollution Control Agency Publication (http://www.pca.state.mn.us/publications/w-hw4-48f.pdf)

Currently, industrial materials such as transformer oils can be treated to chemically destroy PCB's by sodium dehalogenation This allows the valuable base transformer oil to be re-used. PCB ballasts can be processed for metal recovery, however, this leaves a concentrated PCB residue For solid wastes the currently available options for management/disposal are principally permanent storage in a secure landfill (e.g in the United States) or incineration in a suitably controlled, monitored and permitted waste incinerator. The former operation results in a permanent retained liability by the waste generator Incineration, when permitted, is costly and entails risk of atmospheric emissions

Regulations regarding classification and acceptable disposal of PCB solid wastes vary by jurisdiction Some representative regulations for British Columbia, Canada, are:

| Disposal Method | Allowable PCB level in mg/Kg waste |
|---|---|
| Incinerator or secure fill | >50 |
| Industrial fill | >3 and <50 |
| General Landfill | <3 |

Getman et al., in U.S. Pat. No. 6,049,021, describe remediation of soil contaminated with PCB's. This patent describes the destruction of PCB's in soil using a variety of methods involving the following basic steps:

a) PCB extraction of soil by liquid ammonia;

b) dissolution of sodium metal into PCB-contaminated liquid ammonia; and

c) destruction of PCB in liquid ammonia by dissolved sodium metal

Although this technique clearly results in destruction of PCB's in soil it suffers from the following problems:

a) need to refrigerate ammonia with soil while stirring before addition of sodium metal (see Example 4 of Getman et al);

b) need to operate with hazardous pressurized anhydrous ammonia gas in a stirred vessel (see Example 2 of Getman et al);

c) extremely high ammonia dose on soil (e.g 9 litres ammonia per kilogram of soil) (see Example 3 of Getman et al);

d) generation of ammonia-containing residual wastes (i.e “filtrates”) (see Example 2 of Getman et al);

e) awkward temperature cycling between 0° C. and 20 to 40° C. (see Example 4) or −78° C. (see Example 3 of Getman et al); and

f) awkward, time-consuming, multiple soil extractions with ammonia before addition of sodium metal (see Example 4 of Getman et al.)

U.S. Pat. No. 5,228,921, issued to Peterson, describes a method for extracting organohalogens from organohalogen-contaminated solids U.S. Pat. No. 5,376,182, issued to Everett et al., describes PCB extraction from PCB-contaminated soil with ultrasound at 10 to 60 kilohertz frequency Although these extraction methods successfully remove PCB's from soil, critically, they do not destroy the PCB's.

PCT application WO 02122252 of Collings describes ultrasonic destruction of PCB's in a one-step process However, PCB destruction efficiency is low (e g. 75%, see page 10, lines 20 to 25, of Collings).

Eco Logic International, in a brochure dated April 2001 and entitled “The TORBED/GPCR combination for Soil, Sediment and Sludge Treatment,” describe a multi-step process for removal and destruction of PCB's in solids as follows:

1) high temperature (e g. 600° C.) thermal desorption of PCB's from soils by volatilization;

2) high temperature (e g 875° C.) gas phase reduction of volatilized PCB exhaust gas from step 1, with a reducing gas such as hydrogen;

3) scrubbing of exhaust gas from step 2, to recover toxic and/or corrosive gases such as hydrogen chloride produced from reduction of PCB's;

4) compression and/or storage of scrubbed exhaust gas from step 3; and

5) incineration and/or recycling of scrubbed exhaust gas from step 4 to steps 1 and/or 2, respectively

Although the Eco Logic International method clearly destroys PCB's in soils, it suffers from the following problems:

1) generation of toxic and/or corrosive exhaust gas (e g. hydrogen chloride) and spent scrubber solutions;

2) use of potentially explosive hydrogen gas at high temperature;

3) five or more processing steps; and

4) two energy intensive, high temperature processing steps

U.S. Pat. No. 6,555,728 and Canadian Patent No 2,316,409 (Sim et al.) describe the destruction of PCB's in ballast tar/pitch using alkali dispersions of sodium, lithium or potassium. This technology suffers from the following serious disadvantages:

a) requirement for a 20-fold stoichiometric excess of alkali metal, in the form of solid dispersions which are:
(i) substantially more expensive than ingots (e.g sodium dispersions are approx 2 to 4 times more expensive than sodium metal ingots); and
(ii) hazardous to use due to the speed with which they react with parasitic agents, such as water and certain oxygen-containing organics in the tar/pitch (e.g phenolics or carboxylic acids);

b) use of co-solvents (e g. iso-octane, methanol and isopropanol) which boil or evaporate at or below suggested processing temperatures (e g. 90° C.), resulting in wasted solvent and or safety issues due to toxic or flammable vapour discharge;

c) no drying of tar/pitch to remove entrained moisture, which is parasitic to the use of alkali metals and which results in serious safety hazards such as hydrogen discharge from the reaction of alkali metal with water at levels in the air that are above its explosive limit;

d) lack of gas inerting (i.e dry or humid oxygen in air removal via displacement) at the start of alkali contact with the PCB-contaminated media, resulting in a commercially unacceptable safety hazard due to potential hydrogen discharge above its explosive limit;

e) contradictory teachings: both the US and Canadian patents specify that the process be carried out below the flash point of the reaction vessel contents, however, the flash point of methanol, iso-octane and isopropanol (the preferred co-solvents), are according to the Merck Index 12° C., −12° C. and 11.7° C., respectively (i e 78° C. lower than the recommended processing temperature);

f) Sim et al is limited to chemical reaction of HOC's found in fluids, there is no discussion of the separation of contaminants from soil or other solids;

g) because high and low level contaminated materials are required, it is likely that at least one of the materials will have to be transported to another site for decontamination; and

h) excessive amounts of reaction solvent are required to cool the system below 145° C., due to the excessive amount of sodium required, which in turn is partly attributed to lack of gas inerting of the reaction vessel, resulting in parasitic exothermic consumption of sodium via oxygen to form sodium oxide or moisture in air to form sodium hydroxide and hydrogen; and

i) use of expensive solid sodium dispersions

Wylie et al (US Publication No. 2003/0120127, U.S. patent application No. 10/280,996) disclose a method of decontaminating fluids The methods described by Wylie et al are limited to the chemical destruction of HOC's. There is no discussion of the separation of contaminants from soil or other media Further, the invention of Wylie et al. suffers from the following drawbacks:

a) Wylie et al require heating the waste-solvent mix to at temperature of 100-170° C. in order to dissolve asphaltic waste in solvent; and

b) Wylie et al state that the HOC's are reacted with an “alkali metal reactant”, however the only “alkali metal reactant” discussed by Wylie is “an alkali metal dispersion” or an “alkai metal dispersion in an alkali solvent” (as discussed above, such solid sodium dispersions are expensive

U.S. Pat. No 5,690,811, issued to Davis et al. (also published as WO97/14765), describes a method for extracting oil from oil-contaminated soil by mixing with a solvent and subjecting to acoustic energy in the range of 500 Hz to 2000 Hz Davis et al do not describe means for destroying halogenated contaminants, merely a means for separating oil from soil. Further, Davis et al do not suggest that their invention has any potential application in the decontamination of HOC-contaminated media There is no suggestion by Davis et al that the method has any application to the reaction or destruction of HOC's or to the remediation of contaminated media

In addition, the invention of Davis et al. is not commercially feasible because it requires the use of a prohibitively expensive magnetorestrictive material, “Terfenol”, containing 10% by weight of exotic rare earth metals (see, for example, col 3, line 57-col 4, line 27 of Davis et al. and col 3, lines 37-40 of U.S. Pat. No. 4,907,209). The method of Davis et al. is additionally limited by the fact that Davis et al specifically state that there be no cavitation of the soil-solvent mixture

The method of Davis et al is specifically limited to a frequency range of 5-2 kHz, (see, for example, the Abstract, Summary (col 2, lines 12-19) and Detailed Description (col 2, lines 48-50 and col 3, lines 13-19)) Davis does not suggest that other frequencies may be used, or that any advantage might be gained thereby.

Davis et al also require a vertically disposed chamber of uniform cross sectional area so that the solvent can flow upward, while soil falls downward. The chamber has a first pair of flat parallel sides and a second pair of flat parallel sides wherein the first pair of flat parallel sides is substantially greater in width than the second pair of flat parallel sides Transducers are located at the mid-section of one of the widest side of the acoustic chamber The shape of the acoustic chamber and location of the transducers enable the sonic energy to be transmitted without cavitation of the solvent that interferes with the settling of the oil-contaminated soil particles by gravity through the upwardly flowing solvent (Davis et al repeatedly emphasize that cavitation must not occur) The use of sonic energy in the range of 500 to 2000 Hz, and preferably 1250 Hz, is said by Davis et al to more effectively penetrate the oil/soil bond and results in the detachment of the oil from the soil particles. The oil is then dissolved by the upwardly flowing solvent

In addition to PCB's, a number of other HOC's (including pesticides, herbicides, dioxins and furans) have been widely used and released into the environment around the world. Their use has resulted in large numbers of contaminated sites and materials

The prior art methods are unsatisfactory for a number of reasons, as outlined above. Foremost among these reasons is that they are uneconomical, which is in significant part due to the fact that they are limited to using solid Na dispersions In addition, they involve an unacceptable health hazard in that potentially explosive H₂ gas or volatile, combustible solvents are allowed to accumulate in the presence of O₂

Accordingly, there is a need for a safe and economical means for treating HOC-contaminated media to remove and/or destroy the HOC's There is a need for a low temperature process, especially a portable process suitable for processing media at the site of contamination, which can quickly extract and efficiently destroy HOC's in a minimum number of processing steps and using a minimum amount of materials (e.g solvents).

### SUMMARY OF THE INVENTION

The present invention provides a method for extraction and low temperature chemical destruction of HOC's, including Persistent Organic Pollutants (POP's), from contaminated media, such as solid wastes, soils, ballasts, scrap from HOC-contaminated equipment, and distillation residues derived from distillation of solvent-extracted HOCs

The treatment process for HOC-contaminated media comprises the following key unit operations:

a) preparation of a mixture of HOC-contaminated media, (such as soil solids or distillation residue) and a fluid extractant containing a liquid hydrocarbon component in whole or part;

b) agitation of the media/fluid mixture (slurry) using audio frequency sonic mixing (i.e “sonication”), resulting in extraction of HOC's into the hydrocarbon liquid-containing fluid extractant;

c) low temperature (e g. 98° C. or higher) chemical destruction of HOC's, especially extracted HOC's, by contact/reaction with molten sodium; and

d) separation of the hydrocarbon liquid-containing fluid extractant phase from solids by a combination of decantation and froth flotation (before or after HOC destruction)

The process may optionally include a step wherein the hydrocarbon liquid-containing fluid extractant phase (i.e. low HOC) is recycled to treat new HOC-contaminated media (i.e. high HOC).

The temperature of the process materials (i e. the media-fluid slurry) must be raised to the melting temperature of the sodium when the sodium is reacted with the HOC's Maintaining the metal in the molten state improves dispersion of the metal under sonication and improves the rate of reaction with HOC's. For a number of reasons (e.g improved solubility, H₂O removal, reduced viscosity, etc.) it is generally desirable, though not necessary, to maintain the temperature of the process materials at relatively elevated levels However, at stages of the process other than when the sodium is being added or reacted with the HOC's, the temperature of the process materials need not necessarily be above or below the melting point of the sodium

In a suitable aspect of the invention the process includes the use of an inert gas flow, which displaces air with an inert gas such as N₂, Ar or He. Inerting is preferably initiated at the same time as the sonication in step (b) above However inerting can be started sooner or later, bearing in mind that the purpose of the inert gas flow is to displace water vapour so as to minimize the release of H₂ (from reaction of Na with H₂O) thereby reducing the risk of explosion, to reduce parasitic consumption of sodium via reaction with O₂ or H₂O, and to displace O₂ (to further reduce the risk of explosion of any H₂ that may be generated). N₂ is a readily available and economical inert gas, however, other gases may be used (e g argon)

In a suitable aspect of the invention, in step (d) above, the sodium may be added as solid pieces or lumps of metal (as opposed to a dispersion), which is then melted by contact with the media/fluid mixture and dispersed in-situ via sonication Solid pieces of sodium are generally less expensive and safer to handle than dispersions

The sodium may be added as solid metal (either as pieces or a dispersion), which is melted by contact with the media/fluid mixture, or as a pre-melted sodium Since extra care would be required in handling pre-melted sodium the addition of solid sodium is preferred to minimize safety hazards

A sodium dispersion is defined herein as a relatively fine particulate form of metal (e g. often in a liquid such as an oil) that can be readily scattered or disseminated An advantage of a dispersion is that it has a large surface area, making it more reactive, especially in a molten state.

The preparation of the mixture of HOC-contaminated media and the fluid extractant may be preceded by pre-processing steps such as air-drying, sieving and/or comminution of the contaminated media In another suitable aspect of the invention, one such pre-processing step can involve a solvent extraction of HOC's from the original contaminated media, involving extraction of the HOC's into a solvent and distillation of the solvent (e.g isopropanol) to leave a solvent-free extracted residue (i e a second form of contaminated media) Wherein the extracted residue is mixed with a fluid extractant containing a liquid hydrocarbon component and subjected to sonication and reaction with sodium (i e the extracted residue is then treated as contaminated media in step (a)). Such pre-processing steps can be useful in avoiding problems with certain extremely heavy solids (e.g. sand), which may necessitate repeated cleaning of the system due to settling of the extremely heavy solids (e g. settling within plumbing components of the system).

### BRIEF DESCRIPTION OF THE DRAWINGS

The invention itself both as to organization and method of operation, as well as additional objects and advantages thereof, will become readily apparent from the following detailed description when read in connection with the accompanying drawings:

FIG. 1 is a process schematic for HOC extraction using a liquid hydrocarbon extraction fluid;

FIG. 2 is a process schematic for HOG extraction using a combination of water and liquid hydrocarbon extraction fluid;

FIG. 3 is a schematic for an extraction system using a 5 kW vertical sonicator; and

FIG. 4 is a schematic for an extraction system using a 75 kW sonicator

### DETAILED DESCRIPTION OF THE INVENTION

The present invention provides a method for low temperature extraction and chemical destruction of HOC's from contaminated media, including solid wastes, such as soils, ballasts, and scrap from dismantling of PCB-contaminated electrical equipment “Media” or “contaminated media” refers to material containing HOC's, and can also include products of pre-processing steps such as solvent extractions and distillations.

Within the methods of the present invention a key feature is the use of audio frequency sonication devices (also referred to herein as sonic generators orsonicators), such as are described in U.S. Pat. No. 4,941,134 and U.S. Pat. No. 5,005,773, (which are incorporated herein by reference in there entirety) to impart audio frequency vibrations (i e to sonicate) to the slurry (i.e. fluid/media mixture) and to extract the HOC's from the solid media into the extraction fluid Such sonication devices come in two preferred types: sonicating probes which can be placed into direct contact with the slurry, and fluid-containing vessels mounted axially to a resonating member These sonicators have demonstrated large-scale processing capabilities and have shown their potential in over a dozen commercial applications The defining feature of the sonicators is their ability to apply very intense audio frequency vibrational energy to chambers mounted on the vibrating bar or to fluid materials in contact with the bar (in a suitable aspect of the invention, a steel bar) The sonic generators (sonicators) convert electric power, via sequentially activated magnets, to resonant vibrational energy in a steel bar Vibrational energy from the bar is transmitted to an attached cell, through which fluid materials can be pumped and be subjected to intense audio frequency agitation (“sonication”). The vigorous sonication is used in the current process to enhance HOC extraction and enhance the rates of chemical reaction of extracted HOC's with molten sodium. The sonic generator machines are preferably large (beyond bench and lab scale) low frequency sonic generators that have sufficient processing capacity for commercial applications The sonic generators are readily transportable and require no anchoring once on site

Heat generation testwork indicates specific energy inputs for the 20 kW sonic generator ranging upwards from 90 kW/m³ of reactor volume (450 Horsepower/1,000 US gallons) This range of power input is at least an order of magnitude (10 times) greater than is achieved by energy intensive industrial mixing systems such as flotation cells When the power input is as effective as in conventional mixing then the advantage of the generator is in proportion to the energy intensity The high energy intensity is advantageous for chemical process operations where very intense mixing via sonication improves the selectivity or efficiency of the desired chemical reaction

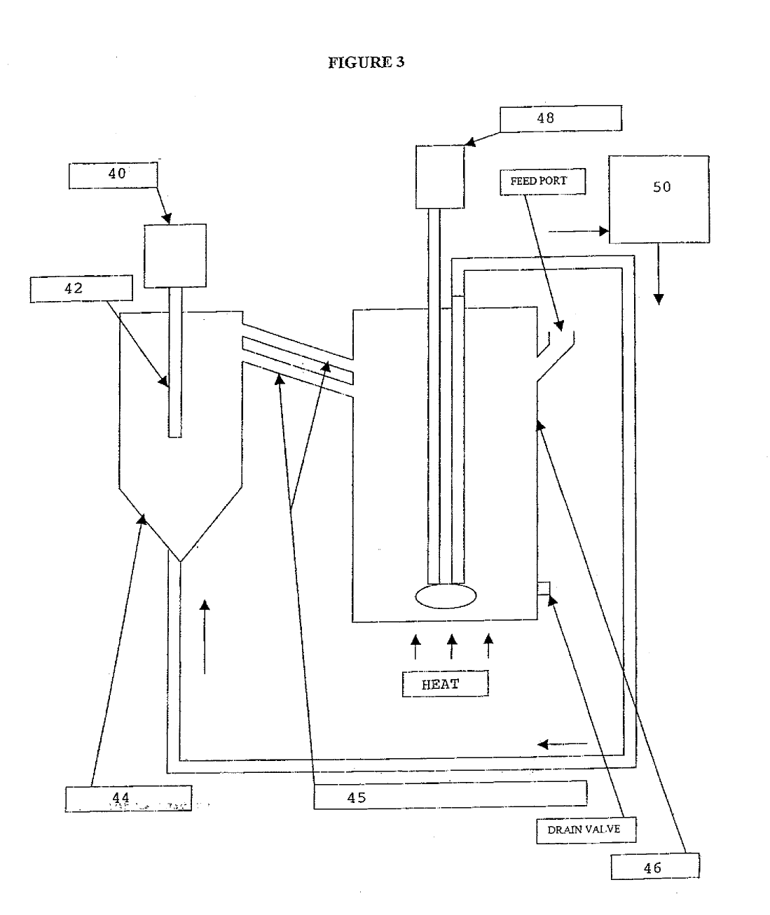

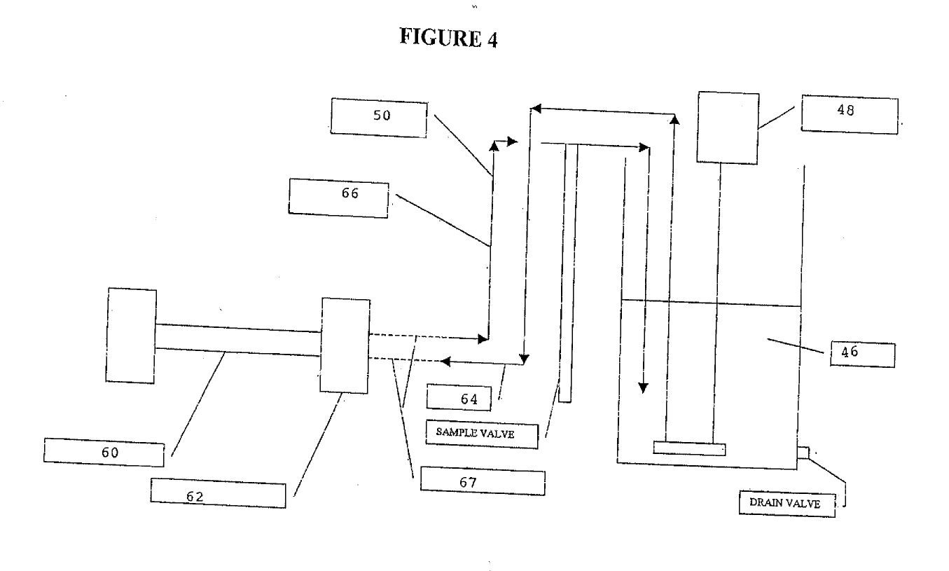

The sonic generators have demonstrated the ability to sonicate fluids and/or liquid-solids mixtures (slurries) at commercially acceptable flow rates. The embodiments of the sonic generators used to date in the present invention have generated in a frequency range from 100 to 500 Hz at power ratings of 75 and 20 kW (horizontal type as illustrated in FIG. 4) and 5 kW for a vertical probe generator with a single drive (illustrated in FIG. 3) The 100 to 500 Hz range has been shown to be effective in carrying out the methods of the present invention However there is no reason to suspect that the invention is limited to that range. It is expected that the methods of the present invention can be carried out using frequencies below 100 Hz and above 500 Hz.

In contrast to Davis et al, (WO97/14765, see for example page 5, line 29-page 6, line 8) the present invention is not limited to frequencies or configurations that avoid cavitation The present invention can be successfully carried out whether or not cavitation takes place. However, Davis et al. indicate that the reason for avoiding cavitation is to permit the soil to settle downward through the upwardly flowing solvent This is in contrast to the present invention where settling is not promoted, and in fact where settling is not desirable to the extent that it interferes with either the thorough mixing of the fluid extractant and contaminated media, or the dispersion of the sodium in the fluid/media mixture For this reason the teachings of Davis et al are considered to be contradictory to those of the present invention

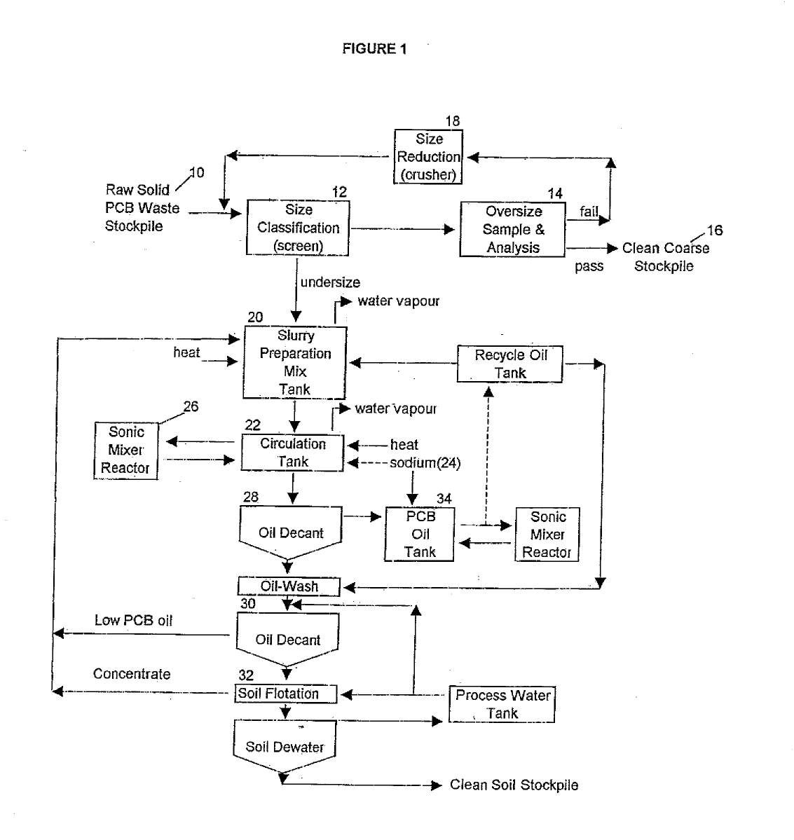

With reference to FIG. 1, a typical sequence of operations for treatment of HOC-contaminated media is as follows:

a) Contaminated solids (10) (i.e contaminated media) from a source or stockpile are classified by size (12) using screens or other conventional technology. The objectives of this step are to ensure that the solids can be pumped when mixed with the hydrocarbon liquid-containing extractant fluid and that the solids are small enough to be extracted within a desired time. Oversize material (14) may in some cases—for example coarse rock in soil—be clean enough for disposal (16) or may be size reduced (18) (e.g. crushed) and returned to the size classifier (12);

b) Feed solids are mixed (20) with the fluid extractant, which contains a hydrocarbon liquid having an atmospheric boiling point substantially above the melting point of sodium (e.g. approx. 120° C.), such as kerosene or fuel oil, to provide a pumpable solid-fluid mixture (i.e. a slurry or a media/fluid mixture) with a typical solids content of 35-70% by weight;

c) The slurry is passed, via a pump or gravity flow, to a heated reservoir/circulation tank (22) where its temperature is raised to 98° C. or more. Heating serves two purposes: (1) removal of free moisture, which would otherwise react with sodium metal (a key process reagent) and (2) establishment of a process temperature above the melting point of sodium so that the sodium metal is molten when it is subjected to intense sonication This facilitates dispersion of the sodium and fast reaction with HOC's which are dissolved in the process fluid

When the slurry is correctly heated and dried, sodium metal (24) is added, preferably as solid pieces that melt in the slurry (the sodium can also be added as a dispersion or as molten liquid) The resulting 3 phase (liquid (extractant)—molten metal—solids (contaminated media)) mixture is pumped through the reaction chamber(s) of a sonic generator (26) where sonic mixing causes the sodium metal to be dispersed in-situ and facilitates extraction of HOC's and concurrent destruction by reaction of the organochlorine with sodium to form sodium chloride (Aromatic-Cl+Na→NaCl+Aromatic) Titration of water soluble NaCl is a standard method for HOC or PCB analysis after Na reduction.

Herein, the invention is described as involving the addition of “sodium” It is understood that this term includes metal that is added to the process in molten form and metal that is added in solid form, (subsequently melting on contact with the media and/or slurry).

On completion of the HOC extraction and the HOC destruction reaction, the slurry is treated to separate the hydrocarbon-containing fluid extractant from the soil. This is achieved by combination of decantation (28, 30) and froth flotation (32) Froth flotation is a widely practiced mineral processing technique (e.g. Taggart, Arthur F, “Handbook of Mineral Dressing”, John Wiley and Sons Inc (New York), 1945 or Gaudin, A M, “Flotation”, McGraw-Hill Book Co Inc (New York), 1957) in which oleophilic materials (oil or hydrocarbon wettable materials and oil or hydrocarbon-containing fluid) are extracted by passage of air bubbles through a fluid mixture (slurry) The flotation process is typically optimized for a particular feed material by adjustment of solution conditions (e.g pH, temperature) and addition of small quantities of chemicals such as frothers, which generate a stable froth layer for removal of oleophilic materials.

A process option, also shown in FIG. 1, is to separate the operations of HOC extraction and destruction. Data presented in the examples below indicate that this approach may be favoured when the HOC solids contain other materials which react with sodium (“parasitic sodium consumption”), for example carboxylates or phenolics To the extent that parasitic consumers are not soluble in the hydrocarbon containing liquid extractant, excess sodium consumption may be reduced by separating (34) the extractant from the (extracted) solids prior to the sodium treatment

A further option, not shown in FIG. 1, is to omit the flotation stage. This option is not typically useful for soils unless a local market is available for the extractant oil wetted solids (e.g asphaltic pavement). However, for wastes such as electrical ballasts and capacitors which have a high hydrocarbon (tar) content, simple removal of process fluid by decantation and/or filtration can result in a conveniently and safely disposable solid

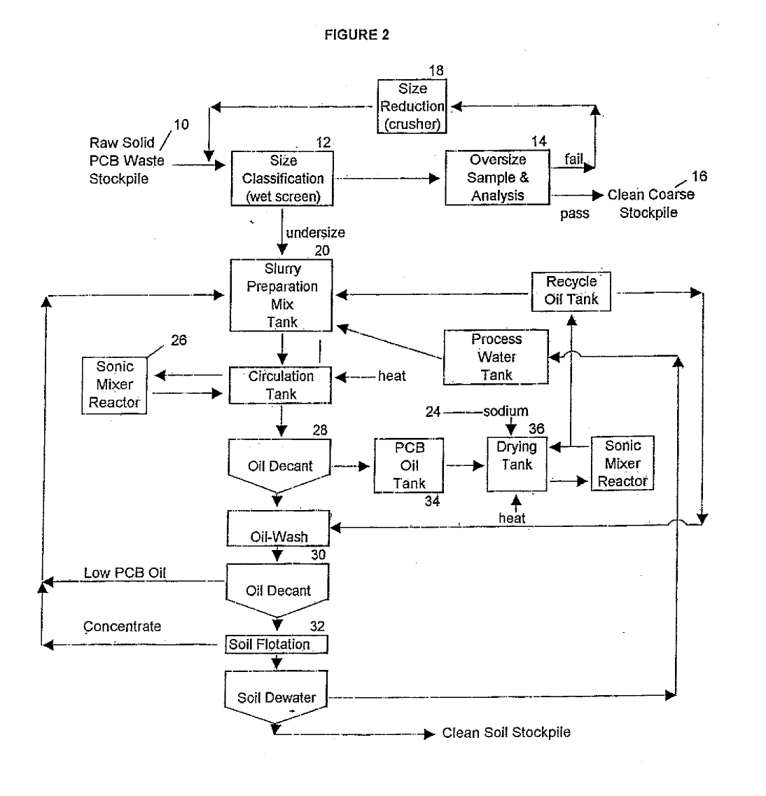

A similar alternative method is shown in FIG. 2 In this case, the fluid extractant is a mixture of water and a hydrocarbon-containing liquid such as kerosene or fuel oil (any of a number of higher molecular weight hydrocarbons (e g petroleum based solvents) could be used in the fluid extractant). The water content of the fluid should be sufficient to make a pumpable slurry when mixed with the solid, for example 35-70% solids/30-65% water, with hydrocarbon containing liquid added in the range of 10-30 wt % of the soil

The key differences between this approach and that of FIG. 1 are:

HOC extraction is conducted at a temperature below 100° C., preferably in the range of 80-98° C.; and

Hydrocarbon-containing liquid, containing extracted HOC's, is separated from the slurry by decantation (28, 34), then heated (36) to a temperature above 100° C. for drying and subsequent sonication with molten sodium metal containing alkali (24)

Typically, the flotation stage (32) is required for recovery of hydrocarbon containing liquid from the extracted solids

Use of water/hydrocarbon-containing liquid for extraction may be favoured when the contaminated solids include a significant proportion of fine grained materials, such as silt or clay, which may be difficult to separate from an oil phase once oil wetting occurs Use of a water/hydrocarbon-containing liquid mixture for HOC extraction largely avoids wetting of naturally hydrophilic solids by the hydrocarbon-containing liquid portion of the fluid This can be optimized by adjustment of the aqueous phase pH

The following non-limiting examples illustrate the effectiveness of the invention:

### EXAMPLE 1

One-Stage Batch Treatment of Soil in Single Vessel with Axial Sonication

A sample of HOC-contaminated soil (in this case, contaminated with PCB's) was obtained from a secure landfill at a Greater Vancouver, Canada location. This fill was constructed for the sole purpose of containing high level (>50 ppm) HOC-contaminated soil and debris from demolition and cleanup of an electrical manufacturing plant site Excavated material was sampled for analysis and all material containing >50 mg/Kg (ppm) of HOC's was placed in the double lined, covered fill The sample of approximately 20 Kg was processed initially over a −6 mesh shaking screen to separate the sieved soil from coarse cobble rock, concrete, steel, and debris

The soil (−6 mesh) was air dried, and then split using a riffle splitter (a device for obtaining representative subsamples of solid materials, see Taggart) to provide representative samples for testwork and analysis.

A 2-kilogram sub-sample of the soil was then mixed with 0.8 L of kerosene and placed in a cylindrical steel reaction chamber Sodium metal in the form of a log block was added to the chamber prior to closure and the chamber was then mounted on the 20 kW sonic generator. The chamber incorporated a heating jacket which was partially filled with ethylene glycol antifreeze to facilitate heat transfer. The mounted chamber was then heated with a propane torch until a charge temperature (thermocouple measured) reached 100° C.

The vent valve on the chamber was then closed and the generator was run at 60% power, 430 Hz resonant frequency for two five-minute periods After each interval, the vent valve was opened to release accumulated pressure Temperature was maintained at >102° C. After 10 minutes of sonic mixing the chamber was dismounted, opened and the contents tested for residual sodium. There was none found, so a further 10 g of sodium was added and the test sequence repeated Product samples were then taken for analysis as follows:

for solids, exhaustive Soxhlet extraction with hexane/acetone (50/50), followed by gas chromatography with an electron capture detector (GC-ECD);

for hydrocarbon containing liquid, dilution with hexane followed by GC-ECD; and

for solids oil content, overnight air drying at 80° C. in a ventilated oven.

Results of PCB analyses were as follows:

| | PCB content |
|---|---|
| | mg/Kg (solids) or mg/L |
| Sample | (hydrocarbon containing liquid) |
| Untreated soil | 470 |
| Soil, first 10 minute test | 98 |
| Soil, second test (total time 20 min) | <2 |
| Hydrocarbon containing liquid | <2 |
| (second test) | |

The treated soil contained 15 5% hydrocarbon containing liquid by weight

The results indicate the feasibility of HOC's destruction to <2 ppm (mg/kg) by treatment with sodium in hydrocarbon containing liquid slurry under sonication.

For the GC-ECD analytical method on heterogeneous samples such as soil, the practical detection limit is 2 mg/Kg (ppm). To quantify the extent of the HOC removal in this initial successful test, the final treated soil was reanalyzed by:

Soxhlet extraction (hexane/acetone);

cleanup of extract by treatment over a Florisil™ absorption column to selectively remove polar and asphaltic components; and

analysis of cleaned extract by Gas Chromatography/Mass Spectroscopy (“GC-MS”) operated in the Selected Ion Mode (“SIM”) The GC-MS-SIM system differentiates between target and background response, permitting a detection limit of 0.4 ppm PCB's By this method, the 30 minute treated sample contained <0.4 ppm (mg/kg) PCB's

### EXAMPLE 2

Batch Treatment of Soil in Single Vessel with Axial Sonication

PCB-contaminated soil was air-dried and sieved to −6 mesh. Two kilograms of soil was combined with 0 6 litres kerosene and 45 grams of solid sodium metal in a 3 2 litre sonication vessel axially mounted to a 20 kilowatt (kW) sonic driver The sealed sonication chamber was heated to 115° C. using heat from a propane torch to melt the sodium metal The sonic chamber heating jacket was filled half-way with ethylene glycol antifreeze to aid in heat transfer to the sonication chamber ingredients. The sonication chamber was opened to sample soil after interval sonic mixing times of 1, 2, and 5 minutes. The presence of sodium was determined by addition of a few drops of water to the analytical sample and observation of effervescence from hydrogen produced by water reaction with residual sodium The following table illustrates HOC destruction as a function of time using the above approach on a soil with an initial PCB content of 424 ppm (mg/kg):

| | Treatment | Treatment | | |
|---|---|---|---|---|
| | Time | Time | PCB | |
| | (minutes) | (minutes) | Content | % PCB |
| Sample | Interval | Total | (mg/Kg) | Destruction |
| Untreated Soil | 0 | 0 | 424 | 0 |
| Sample 1 | 1 | 1 | 12.7 | 97.0 |
| Sample 2 | 2 | 3 | 8.4 | 98.0 |
| Sample 3 | 5 | 8 | 2.2 | 99.5 |

These results indicate that initially the rate of PCB destruction is extremely high, but extended time at temperature with excess sodium is required to achieve low soil residual PCB values.

### EXAMPLE 3

One-Stage Flow-Through Treatment of Soil in Two Vessels with Probe Sonication

To investigate scale-up of the technology, a test system was constructed as follows (shown in FIG. 3):

a slurry reservoir/recirculation tank (46) 24 inches in diameter and 6 feet high was constructed of schedule 80 steel pipe and plate, and mounted on legs to permit heating of the tank bottom plate by a gas burner;

a 10 HP vertical sump pump (48) was installed in the recirculation tank;

a reaction chamber (44) 18 inches in diameter and 3 feet high with a 45° cone bottom was fabricated with 2 side overflow pipe stubs (45) (normal and high level);

the reaction chamber (44) was mounted on an angle iron frame adjacent to the circulation tank (46) and the overflow ports (45) were connected by 4″ diameter nitrile rubber hoses to corresponding pipe stubs on the circulation tank (46);

the 5 kW vertical sonic generator (40) was mounted on the top of the reaction tank (44) so that vibrating probe (42) would be 50% immersed when overflowing through the lower overflow pipe and 75% immersed when discharging through the high level overflow;

This system illustrated in FIG. 3 permitted circulation of slurry (50) through the sonically agitated reaction tank (44) from a relatively large reservoir of process slurry (46)

A new bulk sample from the fill described in Example 1 was obtained and processed in the same manner to prepare 33 Kg of soil for testing

The test was then concluded as follows:

200 L (55 gallon drum) of kerosene was loaded into the reservoir by pump;

the sump pump was started and its speed adjusted to circulate fluid at 500 L/min (+/− 10%);

33 Kg of soil was loaded into the recirculation tank;

the slurry was indirectly heated (while circulating) by propane burners directed at the bottom and sides of the tank;

when the temperature of the circulating slurry reached 105° C., a sample was taken to determine the extent of extraction of PCB from the soil prior to starting the PCB destruction (time=0);

1 5 Kg of sodium metal was added as blocks to the circulation tank, and the 5 kW generator was turned on; and

samples of the circulating slurry were then taken over a period of 105 minutes of extraction/reaction Samples were taken from a drain valve on the pump tank into a steel bucket;

drainable hydrocarbon containing liquid (i e. kerosene plus PCB contaminant extract) was returned to the tank by decantation and solid soil samples (with 15-17% kerosene content) were transferred to sealable glass sample containers for transport to the analytical laboratory

Results of soil analyses were as follows:

| | Sonic Treatment | Sonic Treatment | Soil PCB |
|---|---|---|---|
| | Time (minutes) | Time (minutes) | Content |
| Sample | Interval | Total | mg/Kg |
| Feed Soil | None | None | 1043 |
| Slurry t = 0 | 0* | 0 | 217 |
| Slurry t = 5 | 5 | 5 | 104 |
| Slurry t = 38 | 33 | 38 | 85 |
| Slurry t = 60 | 22 | 60 | 23 |
| Slurry t = 105 | 45 | 105 | <2 |

*approximately 90 minutes of circulation during heating

Excess sodium remained in the slurry at the end of the 105 minute test The new bulk untreated soil PCB content of 1043 ppm illustrates the heterogeneous nature of the landfill (compare to the previous sample containing 430-470 ppm) and the desirability of a blended feed for commercial operation

The final soil PCB content <2 ppm confirms the practicality of treatment at a larger scale

### EXAMPLE 4

One-Stage Flow-Through Treatment of Soil in Two Vessels with Axial Sonication

Following the successful flow-through test using the 5 kW generator, it was determined that commercial feasibility would be favored by use of the largest and highest powered Sonic Generator manufactured to date, the 75 kW horizontal unit This unit also has the advantage of proven reliability, having operated for 6 months in a mine environment with minimal maintenance.

With reference to FIG. 4 the pilot test system was altered by:

Changing the pump/pipe configuration to feed (see below) a new reaction chamber (62) mounted on the 75 kW generator (60). The reaction chamber feed and discharge lines (64, 6) 6 are axial entry/exit;

The schedule 40 steel pump discharge and return lines (64, 66) are isolated from the generator vibration by 4′ lengths of nitrile hose (67), with secondary confinement (in the event of fatigue failure) by a light gauge nitrile rubber tube;

Design and manufacture of a new reaction chamber (62) to minimize short circuiting and maximize mixing intensity

A new bulk 0 8 tonne sample was also obtained from the site described in Example 1 and processed in the same manner to provide a uniform feed for tests to investigate a variety of operating parameters After shakedown tests to confirm mechanical operability, the initial test on the 75 kW generator was performed as follows:

Load 200 L of kerosene into the pump tank

With the circulation pump on, load 44 Kg of soil into the pump tank

Heat the circulating mixture to 105° C. using gas fired torches on the bottom and sides of the circulation tank

Sample oil phase for HOC content (Sample #1)

Start generator at 105 Hz/10 kW Power setting (nominal Time=0 minutes)

Shut down to repair chamber leaks (mixing time approximately 2 minutes) sample from tank drain valve (sample #2)

reheat slurry with circulation and sonication at 105 Hz, 10-11 kW Power (45 minutes to heat from 40° C. to 110° C.)

sample #3 at 110° C.

Add 125 g sodium metal (1 block) to pump tank

Sample #4 after 30 minutes

Add 125 g sodium (1 block)

Sonicate for 15 minutes

Add 250 g sodium (2 blocks)

Sample #5, 30 minutes after sodium addition

Add 125 g sodium (1 block)

Sample #6, 30 minutes after sodium addition

Add 125 g sodium (1 block)

Sample #7, 30 after sodium addition

Add 125 g sodium (1 block)

Sample #8, 30 minutes after sodium addition

Add 125 g sodium (1 block)

Sample #9, 30 minutes after sodium addition

Add 125 g sodium (1 block)

Sample #10, 30 minutes after sodium addition (This sample was for hydrocarbon 1 5 containing liquid phase plus approximately 4 Kg/2 L of soil solids for hydrocarbon containing liquid—soil separation testing)

Results of hydrocarbon containing liquid phase analysis were as follows:

| | | Hydrocarbon- | |
|---|---|---|---|
| | Solid | Containing | |
| | Phase PCB | Liquid Phase | |
| Sample | Content | PCB | |
| No | mg/Kg | mg/L | Notes |
| Feed | 525 | — | 1 36% Moisture |
| Solids | | | |
| 1 | | 180 | PCB extraction during heating |
| | | | cycle to 105° C. |
| 2 | | 191 | Approx 2 minutes of sonication |
| | | | before shutdown for mechanical |
| | | | problem |
| 3 | | 247 | After reheat to 110° C. approx |
| | | | 45 minutes with sonication |
| 4 | | 215 | After 125 g sodium addition 30 |
| | | | minutes sonication at |
| | | | 110-112° C., no excess sodium |
| 5 | | 127 | After 250 g sodium addition |
| 6 | | 114 | After 125 g sodium addition, 30 |
| | | | minutes sonication |
| 7 | | 90 | After 125 g sodium addition, 30 |
| | | | minutes sonication |
| 8 | | 61 | After 125 g sodium addition, 30 |
| | | | minutes sonication |
| 9 | | 44 | After 125 g sodium addition, 30 |
| | | | minutes sonication |
| 10 | | 39 | After 125 g sodium addition, 30 |
| | | | minutes sonication (apparent |
| | | | slight sodium residual) |

These results indicate the feasibility of PCB reduction by sodium addition to slurry using the 75 kW generator The results also indicate that the chemical efficiency of the sodium destruction of PCB's decreases as the hydrocarbon containing liquid phase PCB concentration is decreased below (about) 125 mg/L

### EXAMPLE 5

Sonicated Hydrocarbon Containing Liquid-Soil Separation

As previously noted, clean soil recovered by decantation of hydrocarbon containing liquid after extraction and PCB destruction contains 15-17 wt % of hydrocarbon containing liquid phase Recovery of this hydrocarbon containing liquid is important in relation to both process economics (cost of hydrocarbon containing extractant) and final disposal of the clean soil

To investigate recovery of hydrocarbon containing liquid from treated soil (Example 4, Sample #10), an initial froth flotation test was conducted as follows:

Transfer 500 g of hydrocarbon containing, liquid saturated soil (sample #10 decanted) to a 2 L laboratory flotation cell;

Add 1 6 L of hot (60° C.) water and mix (condition) the soil—hydrocarbon containing liquid—water slurry for 2 minutes at 1500 rpm using a Denver D4 (Denver Equipment Co) laboratory flotation machine;

Stop the agitator and—after 2 minutes of quiescent settling—decant the separated free floating hydrocarbon containing liquid phase;

Agitate (condition) for a further 2 minutes;

Add further hot water (approx 0.1 L) to bring the pulp (liquid-solid slurry) level within about 1 cm of the cell overflow;

With aeration controlled by the machine's air intake valve, manually remove froth for 35 minutes, periodically adjusting pulp volume with hot water to compensate for volume of froth removed until the froth was visually free of solids;

Stop agitation, settle 1 minute;

Decant water;

Record wet weight clean soil; and

Sample wet soil for analysis.

Analysis of the clean soil indicated:

| | | | | Solids | |
|---|---|---|---|---|---|
| | | PCB | Oil & | Recovery | Hydrocarbon |
| | | content | grease | (wt % | Containing |
| | | (as | (as | of feed, | Liquid |
| | Moisture | received) | received) | dry | Recovery |
| Sample | % | mg/Kg | mg/Kg | basis) | (%) |
| Clean | 14.6 | 1.7 | 1800 | 96 | >98 |
| Soil | | | | | |
| (flotation | | | | | |
| tailing) | | | | | |

These results indicate that froth flotation, a commonly practiced industrial process, is effective for recovery of hydrocarbon containing liquid from cleaned soil It is of interest to note to that the residual PCB content of the cleaned soil, although low enough to meet stringent disposal criteria, is higher than can be accounted for by its residual oil and grease content if it is assumed that the residual hydrocarbon containing liquid contains the same (39 mg/L) PCB content as the bulk hydrocarbon containing liquid separated from the solids at the end of the extraction/destruction test (Example 4, Sample 10)

These data also demonstrate that complete destruction of HOC's in the hydrocarbon containing liquid phase is not necessary in order to produce acceptably low HOC's content in cleaned soil for disposal. This is an important factor for process economics, since the results of the Example 4 indicate that the chemical efficiency of sodium destruction of PCB's decreases as the residual PCB's concentration is lowered and becomes prohibitively inefficient below (about) 60 ppm PCB

### EXAMPLE 6

Sonicated Hydrocarbon Containing Liquid-Soil Separation with Additives

The procedure followed in Example 5 was repeated with the following modifications:

The water additions were pre-heated to about 90° C.

A commercial frothing agent (Dowfroth™ 250, polyglycol, average molecular weight=250) was added incrementally to a total dosage of 20 g/tonne of feed solids to generate and maintain a better froth than was obtained in the initial tests to which no chemical was added

Pulp (liquid-solid slurry) pH was adjusted to 11.5 with sodium carbonate (0.5 Kg/tonne of feed).

Analysis of clean soil from this test indicated:

| | | | | Hydrocarbon |
|---|---|---|---|---|
| | PCB | Oil & | Solids Recovery | containing |
| | content | grease | (wt % of feed | liquid |
| Sample | mg/Kg | mg/Kg | dry basis) | recovery (%) |
| Clean | <1 | 421 | 95 | >99 |
| (flotation | | | | |
| tailing) | | | | |

These data confirm the utility of froth flotation for hydrocarbon containing liquid-soil separation and indicate that manipulation of conditions such as pH and frother dosage can be used to optimize the process.

### EXAMPLE 7

Two-Stage Flow-Through Treatment of Soil in Two Vessels

Soils contain varying quantities of organic matter and other materials which may compete with HOC's for reaction with sodium-containing alkali. To investigate the effect of separating the HOC extraction and destruction operations, the following test sequence was conducted:

150 L of used hydrocarbon containing liquid from the test of Example 4 was returned to the circulation tank with 45 7 Kg of PCB soil bulk sample

This mixture was heated to 110-115° C. and treated through the 75 kW Sonic generator chamber for 3 hours at 105 Hz, 10-12 kW power (Note: use of low power settings relative to the generator's 75 kW maximum was based on supplying a mixing power intensity similar to what would be achieved in the next stage of scale up Using chambers on each end of the generator (e.g see also FIG. 9A in U.S. Pat. No. 5,005,773) and increasing power to 75 kW will provide the same power input (kW/tonne) to approximately 15× as much material, i.e a batch size of 0.6-1 tonne Larger batches can be treated at equivalent power input by extending treatment time or providing more generators.)

Hydrocarbon containing liquid phase samples from this test were analyzed, indicating:

| | Sonic | | |
|---|---|---|---|
| | Treatment Time | PCBs | |
| Sample No | (minutes) | mg/L | Notes |
| 0 | 0 | 44 | Recycled hydrocarbon |
| | | | containing liquid |
| 1 | 15 | 190 | Extraction from 45 minutes heat |
| | | | up plus 15 minutes sonic |
| | | | treatment |
| 2 | 45 | 215 | |
| 3 | 135 | 213 | |
| 4 | 195 | 219 | |

Since the precision of PCB analytical results is typically +/−10%, these data indicate substantially complete reaction within 45 minutes and >90% extraction within the heating time +15 minutes of sonication

The reacted slurry was drained from the circulation tank and primary hydrocarbon containing liquid-soil separation was performed by manual decantation. Recovered hydrocarbon containing liquid, 140 L, was returned to the circulation tank along with 60 L of used hydrocarbon containing liquid accumulated from other tests The combined hydrocarbon containing liquid sample was then heated to 110° C. under a nitrogen purge gas flow and pumped through the generator chamber (10-11 kW, 105 Hz) while adding increments of sodium metal

Test analytical results were as follows:

| | | Sodium | Sodium | |
|---|---|---|---|---|
| Sample | PCB | addition(g) | addition(g) | |
| No. | (mg/L) | interval | cumulative | Notes |
| 1 | 271 | 0 | 0 | Blended |
| | | | | hydrocarbon |
| | | | | containing liquid |
| 2 | 177 | 200 | 200 | |
| 3 | 90 | 200 | 400 | |
| 4 | 45 | 200 | 600 | |

These data show the same trend as results from Example 4, i e the chemical efficiency of sodium reduction of HOC's decreases as the residual HOC decreases, particularly below 100 ppm. However, the overall sodium efficiency for this test is approximately 28% improved relative to results of Example 4.

Since the cost of sodium metal (Canadian Dollars $3/lb in bulk) is estimated to be the largest single component of treatment operating cost, hydrocarbon containing liquid—soil separation before sodium treatment may thus be a preferred option for process operation on soils with high parasitic sodium consumption

### EXAMPLE 8

Two-Stage Flow-Through Treatment of Soil in Two Vessels with Hydrocarbon Containing Liquid/Water Extractant

Since the sodium-containing alkali efficiency is better at higher PCB concentrations in the hydrocarbon containing liquid extractant, consideration was given to conducting the sonic extraction with a fluid mixture of water and hydrocarbon containing liquid to achieve a higher PCB concentration in the hydrocarbon containing liquid phase. It was also hypothesized that water soluble and more hydrophilic components of the soil (probable contributors to parasitic sodium consumption) might be retained in the aqueous phase

A laboratory scale scoping test provided encouraging results (1700 mg/L PCB in the hydrocarbon containing liquid phase), so a pilot scale test was conducted as follows:

load 110 L of water and 20 L of kerosene to the circulation tank;

heat mixture to 92° C. while circulating with the pump;

load 46 3 Kg of bulk soil sample;

sample (hydrocarbon containing liquid i.e kerosene rich phase);

set generator to 10-11 kW for intensive mixing of circulating slurry; and

at 120 minutes, sample circulating slurry for hydrocarbon containing liquid phase analysis and soil cleanup testing (see below).

Results of hydrocarbon containing liquid phase analyses were as follows:

| | Sonic Extraction | | |
|---|---|---|---|
| Sample No | Time (minutes) | PCB content mg/L | Notes |
| 1 | 0 | 1616 | Hot pump |
| | | | circulation |
| 2 | 120 | 1747 | Sonication |

These results confirm the practicality of obtaining a high hydrocarbon containing liquid phase PCB content by extraction of soil with a water-hydrocarbon containing liquid fluid mixture.

To assess final soil cleanup, the 120 minute slurry sample was treated as follows:

decant fluid hydrocarbon containing liquid and water phases from settled solids;

heat the fluid phase mixture to 90° C.;

transfer to a separatory funnel and decant the aqueous (sink) phase;

transfer 500 g of soil solids (saturated) to the flotation test apparatus described in Example 5;

add aqueous phase from the water-hydrocarbon containing liquid separation (approximately 1 75 L) to the cell to permit froth overflow;

condition (mix) for 2 minutes, then float for 30 minutes (Solution pH 11 7 throughout test; initial froth quality was poor, but it improved throughout the test);

shut down flotation and decant remaining water;

record soil wet weight;

air dry soil overnight, record dry weight;

submit soil sample for PCB analyses

Cleaned soil parameters were as follows:

Wet Weight (from 500 g wet feed) 395 g (˜80% recovery);

Dry Weight 335 g; and

Dry basis PCB content 48 mg/Kg.

These results demonstrate the practicality of recovering >90% of soil PCB content in a single stage of water-hydrocarbon containing liquid extraction to produce hydrocarbon containing liquid phase PCB contents in the 1750 mg/kg range. The PCB content of the cleaned soil was marginal with respect to applicable disposal criteria (maximum 50 ppm PCB's for secure landfill disposal vs incineration or other PCB destruction technology required for waste >50 ppm PCB). Thus a second counter-current stage of extraction with low PCB hydrocarbon containing liquid will be required with the water-hydrocarbon containing liquid sonication

Hydrocarbon containing liquid phase from the water-hydrocarbon containing liquid decantation was transferred to a laboratory (low intensity) mixing system, heated to 110-115° C. and treated with incremental doses of granular (3×0 1 mm) sodium to investigate the efficiency of sodium HOC reaction using the high PCB hydrocarbon containing liquid extract, with the following results:

| | | Sodium Dose | Sodium Dose | |
|---|---|---|---|---|
| Sample | PCB | (g/L) | (g/L) | |
| No. | (mg/L) | Interval | Cumulative | Notes |
| 1 | 1832 | 0 | 0 | Concentration |
| | | | | increase from |
| | | | | 1747 due to |
| | | | | evaporation |
| 2 | 126 | 2.6 | 2.6 | Apparent high |
| | | | | sodium efficiency |
| 3 | 34 | 2.6 | 5.2 | Efficiency loss at |
| | | | | low PCB |

These data indicate a significant improvement in sodium efficiency compared to the results of Example 7. For PCB reduction from 1832 to 126 mg/L (93% destruction) the sodium consumption was only 5 times the stoichiometric requirement, compared to 30 times to reach 45 mg/Kg in Example 7. For reduction of PCB from 126 to 34 mg/L, the stoichiometric excess sodium requirement increases to about 87 times, which clearly indicates the desirability (in terms of sodium efficiency) of high PCB content hydrocarbon containing liquid phase extract. However, the overall efficiency in this example (from 1832 to 34 mg/L) is about 10× stoichiometric, which is a very significant improvement over the 30× stoichiometric requirement in Example 7

### EXAMPLE 9

Extraction and Destruction of PCB's from Electrical Ballasts

A sample of concentrated ballast tar was obtained from Contech Ltd Richmond, BC. Contech is a firm, which uses proprietary technology (low temperature attrition scrubbing) to recover metal components from scrap PCB ballasts The metal fraction, containing typically <40 mg/Kg of PCB's is sold to a copper recycling operation The separated tarry (high PCB) fraction, with residual metallics, paper, and debris, is shipped to licensed hazardous waste incinerator operators in Alberta for destruction.

The ballast tar sample provided (11 1 Kg, approx. 18 L volume, i.e. low bulk density) was processed initially in the pilot system as follows:

transfer 100 L of fresh kerosene and 11 1 Kg ballast tar to circulation tank and heat to 105° C. while circulating with the pump (2 h contact time at T >60° C.);

start inert gas flow and sonic generator at 10 kW; and

after 15 minutes of sonic extraction, take baseline sample for hydrocarbon containing liquid phase PCB and commence incremental sodium addition

The initial phase of the test was shut down after 165 minutes of sonication for two reasons: high sodium demand and visual observation of relatively large undispersed tar particles A review of literature on ballast components was undertaken and this revealed that the air-blown asphalt component contains a high proportion of phenolic (effectively acidic) materials.

The test system was then re-started and 150 g each of coarse and fine quick lime (calcium oxide) was added to neutralize acidic (sodium consuming) components of the mixture. The sample was then treated for a further 270 minutes with sonication and incremental sodium addition

Test data are summarized as follows:

| | | PCB | | | |
|---|---|---|---|---|---|
| | | hydrocarbon | | | |
| | PCB | containing | Sodium | Sodium | |
| Sample | solids | liquid | Addition | Addition | |
| No | (mg/Kg) | (mg/L) | interval | cumulative | Notes |
| Ballast | 1200 | — | — | — | +20% |
| Tar | | | | | due to |
| | | | | | hetero- |
| | | | | | geneous |
| #1 | — | 112 | 0 | 0 | |
| #2 | — | 112 | 125 | 125 | |
| #3 | — | 105 | 0 | 125 | |
| #4 | 60 | 97 | 150 | 275 | |
| #5 | 43 | 92 | 0 | 275 | |

Shutdown after 270 minutes Restart with 30 Kg/tonne lime addition

| | | PCB | | | |
|---|---|---|---|---|---|
| | | hydrocarbon | | | |
| | PCB | containing | Sodium | Sodium | |
| Sample | solids | liquid | Addition | Addition | |
| No | (mg/kg) | mg/L | Interval | cumulative | Notes |
| 1A | — | 106 | 0 | 275 | Note |
| | | | | | increased |
| | | | | | extraction |
| | | | | | in heat up |
| 2A | — | 9 | 125 | 400 | Apparent |
| | | | | | major |
| | | | | | improvement |
| | | | | | in sodium |
| | | | | | efficiency |
| 3A | — | 6 | 125 | 525 | |
| 4A | — | 8 | 0 | 525 | |
| 5A | 4 | 7 | 0 | 525 | |

These data confirm the practicality of treating ballast tar in kerosene by sonication and sodium PCB reduction, as well as indicating a favourable effect of quicklime addition in relation to sodium efficiency

The time (270 minutes) of hot sonication required to achieve 43 ppm residue PCB content indicates the difficult (relative to soil) extraction behaviour of ballast tar. However, this could be mitigated by comminution of the feed material, which was relatively coarse (˜10% +¼″).

### EXAMPLE 10

Confirmation Test—Sodium Efficiency Improved by Lime Addition

A further test was done according to the procedure of Example 9 with the following adjustments:

A new ballast sample was used and tar content of the feed was increased to 29 Kg/100 L of kerosene;

Sonic mixing time before sodium addition was increased to 9 hours;

Lime (50 g/Kg of tar) was added to the tar-kerosene slurry after 8 h of mixing (i e. 1 h before the first sodium addition); and

Sodium was added incrementally in two 1 0 g/L (100 g/100 L hydrocarbon containing liquid phase) doses, allowing 2 h of mixing time between sodium addition and subsequent sampling to ensure complete reaction.

Analytical results are summarized as follows:

| | | PCB | PCB | Sodium Dose | Sodium Dose | |
|---|---|---|---|---|---|---|
| Sample | | Solids | Liquid | (g/100 L) | (g/100 L) | |
| No. | | (mg/L) | (mg/L) | Interval | Cumulative | Notes |
| Ballast Tar | | 1760 | — | — | — | +/−20% due to |
| | | | | | | heterogeneous |
| | | | | | | sample |
| 1, | Liquid | — | 510 | 0 | 0 | |
| | Extract | | | | | |
| 2, | First | — | 180 | 100 | 100 | Large increase |
| | Reduction | | | | | in initial sodium |
| | | | | | | efficiency |
| 3, | second | — | 57 | 100 | 200 | Equivalent to |
| | reduction | | | | | Example 9, |
| | | | | | | Samples 1A & |
| | | | | | | 2A |

The initial hydrocarbon extract PCB content in the test was higher than for Example 9 due to the higher ratio (29 Kg/100 L vs. 11 1 Kg in Example 9) and also to the higher PCB content (1760 mg/Kg) of the new sample.

The effect of the lime addition on the initial sodium efficiency in this test is illustrated by comparing the change in hydrocarbon PCB content for Example 9 between Sample #1 and #5 (PCB reduced from 112 to 92 mg/L after addition of 275 g sodium/100 L of extract) with the 510 to 180 mg/L PCB reduction after addition of 100 g sodium/100 L in the current test with lime added before any sodium addition The initial sodium efficiency in this testis approximately 60 times greater than in Example 9 (before lime addition).

For the second sodium treatment in the current example, the reduction in PCB content (Sample 3-2; 150−57=123 mg/L for a 100 g/100 L sodium addition) compares favourably to the second phase of Example 9 (Sample 2A vs 1A; 106−9=97 mg/L for a 125 g/100 L sodium addition) However, the sodium efficiency ratio between this example (samples 2 and 3) and Example 9 (samples 1A and 2A) is only 1.6 Considering the previously noted trend to lower sodium efficiency at lower PCB concentrations, these results are considered to be equivalent

Overall, results of this example confirm the favourable effect of lime addition on sodium efficiency on treatment of ballast tar by hydrocarbon PCB extraction/sodium PCB destruction

### EXAMPLE 11

DDT (Diphenyltrichloroethane) is a pesticide once widely used to control insects in agriculture and insects that carry diseases, such as malaria. Its use in the United States was banned in 1972 because of damage to wildlife and the environment but it is still used in some countries.

Analytical standard DDT was dissolved in kerosene and treated with sonically dispersed molten sodium at 110° C. Periodic samples were removed for analysis by gas chromatography The results confirmed the destruction of the DDT.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the scope of the invention

1. A method for treating media containing halogenated organic compounds, comprising the steps of:
a) combining said media with a fluid extractant to form a media/fluid mixture, said fluid extractant containing one or more liquid hydrocarbons;
b) substantially contemporaneously:
i) heating said media/fluid mixture to a temperature at or above a melting temperature of sodium;
ii) sonicating said media/fluid mixture at audio frequency; and
iii) adding sodium to said media/fluid mixture;
wherein said sonication causes said sodium to be dispersed in said media/fluid mixture; and
wherein said sodium reacts with said halogenated organic compounds

2. The method of claim 1, wherein an inert gas is used to displace at least one of hydrogen, oxygen and water vapour from the airspace above said media/fluid mixture

3. The method of claim 2, wherein said inert gas is one of nitrogen and helium

4. The method of claim 1, wherein said halogenated organic compounds are one of chlorinated organic compounds, brominated organic compounds, PCB's, herbicides, pesticides, dioxins, POP's and furans.

5. The method of claim 1, wherein said media/fluid mixture is heated prior to and during said sonicating step

6. The method of claim 1 wherein said media is one of soil, distillation residue and ballast residue

7. The method of claim 1 wherein said fluid extractant contains a mixture of water and one or more liquid hydrocarbons

8. The method of claim 1 wherein said liquid hydrocarbon is one of kerosene and fuel oil.

9. The method of claim 1, wherein prior to said combining step said media is subjected to one of air drying, sieving, comminution, pulverization, distillation and extraction.

10. The method of claim 1 wherein said sonication step occurs in a sealed vessel with a vent to release gas during sonication.

11. The method of claim 1 wherein said sonication step occurs in a vessel with one or more inlets and outlets able to transfer said media/fluid mixture between said vessel and a reservoir.

12. The method of claim 1, wherein said fluid extractant is separated from said media after addition of said sodium

13. The method of claim 13, wherein said fluid extractant is separated from said media by decantation and froth flotation.

14. The method of claim 1, wherein said sonication step includes the addition of lime to said media/fluid mixture

15. The method of claim 1, wherein said sodium is added to said media/fluid mixture in the form of solid ingots which are melted by contact with said media/fluid mixture

16. The method of claim 1, wherein said sodium is added to said media/fluid mixture as molten sodium

17. The method of claim 1, wherein said media/fluid mixture is sonicated at a frequency in a range of 100 Hz to 500 Hz

18. A method for treating media containing halogenated organic compounds, comprising the steps of:
a) combining said media with a fluid extractant to form a media/fluid mixture, said fluid extractant containing one or more liquid hydrocarbons;
b) sonicating said media/fluid mixture at audio frequency;
c) separating said fluid extractant from said media/fluid mixture;
d) substantially contemporaneously:
i) sonicating said fluid extractant at audio frequency;
ii) heating said fluid extractant to a temperature at or above a melting temperature of sodium; and
iii) adding sodium to said fluid extractant;
wherein said sonication causes said sodium to be dispersed in said fluid extractant; and
wherein said sodium reacts with said halogenated organic compounds.

19. The method of claim 18, wherein said fluid extractant is separated from said media by decantation and froth flotation.

20. The method of claim 18, wherein after said separation, said media is treated with water in a flotation cell to dislodge residual amounts of said fluid extractant, and wherein said residual fluid extractant is separated from said media.

21. The method of claim 18 wherein said separated fluid extractant is combined with additional media containing halogenated organic compounds

22. The method of claim 21 wherein one of a frothing agent and a pH adjustment agent is added to said flotation cell.

23. The method of claim 22, wherein said pH adjustment agent is sodium carbonate.

24. The method of claim 18, wherein an inert gas is used to displace at least one of hydrogen, oxygen and moisture from the airspace above said fluid extractant.

25. The method of claim 24, wherein said inert gas is one of nitrogen, argon and helium

26. The method of claim 18 wherein said sonication of said fluid extractant includes the addition of lime to said fluid extractant.

27. The method of claim 26 wherein said sonication steps occur in a sealed vessel able to be vented to release gas during sonication

28. The method of claim 18 wherein said liquid hydrocarbon is one of kerosene and fuel oil.

29. The method of claim 18, wherein said media/fluid mixture is sonicated at a frequency in a range of 100 Hz to 500 Hz

30. The method of claim 18, wherein said sodium is added in the form of solid ingots which are melted by contact with said fluid extractant

31. The method of claim 18, wherein said sodium is added as molten sodium

32. The method of claim 18, wherein during step (b) said media/fluid mixture is heated to a temperature in a range of about 80° C.-98° C.
